(19) United States
(12) Patent Application Publication
(10) Pub. No.: US 2018/0321653 A1
(43) Pub. Date: Nov. 8, 2018

(54) METHOD AND SYSTEM FOR DYNAMIC PROCESS WINDOW MANAGEMENT IN EQUIPMENT DAMAGE PREDICTION

(71) Applicant: Honeywell International Inc., Morris Plains, NJ (US)

(72) Inventors: Sridhar Srinivasan, Houston, TX (US); Pierre Constantineau, Saskatoon (CA)

(21) Appl. No.: 15/589,739

(22) Filed: May 8, 2017

(51) Int. Cl. G05B 19/048; G06N 5/02

(52) U.S. Cl. CPC G05B 19/048; G05B 2219/24015; G06N 5/022

(57) ABSTRACT

A method includes obtaining data associated with a plurality of variables of an industrial process and obtaining an indication of an acceptable damage rate to equipment that is used in the industrial process. The method also includes obtaining a damage prediction model for the equipment, where the damage prediction model mathematically represents expected damage to the equipment based on the plurality of variables. The method further includes determining at least one of a high limit and a low limit for each of the plurality of variables based on predicted damage rates to the equipment that are determined using the data and the damage prediction model.

### TECHNICAL FIELD

This disclosure generally relates to industrial process control and automation systems. More specifically, this disclosure relates to a method and system for dynamic process window management in equipment damage prediction and correlating process parameters to equipment damage prediction.

### BACKGROUND

Industrial processes often cause “wear and tear” on processing equipment in industrial facilities, which may be referred to as damage or corrosion. To prevent operating scenarios that cause damage to processing equipment at unacceptable rates, operating limits may be set on process variables. These operating limits are often based on industry standards and knowledge of the personnel designing the limits. These limits are also typically designed in light of planned operating conditions for the processing equipment and do not account for possible changes in operating conditions over time.

### SUMMARY

This disclosure provides a method and system for dynamic process window management in equipment damage prediction.

In a first embodiment, a method includes obtaining data associated with a plurality of variables of an industrial process and obtaining an indication of an acceptable damage rate to equipment that is used in the industrial process. The method also includes obtaining a damage prediction model for the equipment, where the damage prediction model mathematically represents expected damage to the equipment based on the plurality of variables. The method further includes determining at least one of a high limit and a low limit for each of the plurality of variables based on predicted damage rates to the equipment that are determined using the data and the damage prediction model.

In a second embodiment, an apparatus includes at least one memory configured to store data associated with a plurality of variables of an industrial process, an indication of an acceptable damage rate to equipment that is used in the industrial process, and a damage prediction model for the equipment. The damage prediction model mathematically represents expected damage to the equipment based on the plurality of variables. The apparatus also includes at least one processing device configured to determine at least one of a high limit and a low limit for each of the plurality of variables based on predicted damage rates to the equipment that are determined using the data and the damage prediction model.

In a third embodiment, a non-transitory computer readable medium contains computer readable program code that when executed causes at least one processing device to obtain data associated with a plurality of variables of an industrial process and to obtain an indication of an acceptable damage rate to equipment that is used in the industrial process. The medium also contains computer readable program code that when executed causes the at least one processing device to obtain a damage prediction model for the equipment, where the damage prediction model mathematically represents expected damage to the equipment based on the plurality of variables. The medium further contains computer readable program code that when executed causes the at least one processing device to determine at least one of a high limit and a low limit for each of the plurality of variables based on predicted damage rates to the equipment that are determined using the data and the damage prediction model.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example industrial process control and automation system according to this disclosure;

FIG. 2 illustrates an example process window management system according to this disclosure;

FIG. 3 illustrates an example device for process window management according to this disclosure;

FIG. 4 illustrates an example method for process window management according to this disclosure;

FIGS. 5 and 6 illustrate example graphs that plot a process variable versus predicted damage rates with respect to a process window according to this disclosure;

FIGS. 7A through 7E illustrate example graphs of results of damage rate simulations for a specific example process window according to this disclosure.

### DETAILED DESCRIPTION

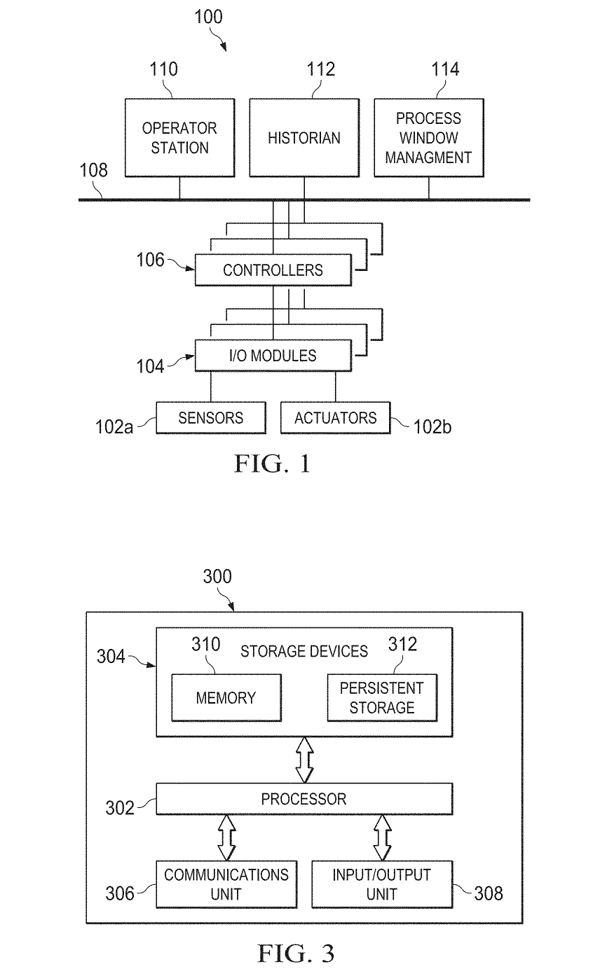

FIGS. 1 through 7E, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

As noted above, industrial processes often cause “wear and tear” on processing equipment in industrial facilities. The level of wear and tear (also referred to as damage or corrosion) on process equipment is typically monitored, and the process equipment is repaired or replaced when considered too damaged for safe operation. Managing the rate of damage to process equipment in industrial facilities can be useful to extend the safe operating life of the process equipment. Integrity Operating Windows (IOWs) are one component of damage management. An IOW includes upper and lower limits (or boundaries) on process variables in an industrial process and are designed to constrain operation of the process equipment within limits where damage rates are acceptable.

The IOW limits are typically determined based on historical process data and expected normal operating conditions of an industrial facility. These limits are also typically determined at one point in time and are static, meaning the limits are not updated. However, operating conditions in an industrial facility may gradually change over time due to normal operation of the facility, which may include changes to process inputs and throughputs or equipment optimizations. Additionally, process variables may have complex interactions with each other that result in unexpected changes in rates of damage correlated to one process variable that are caused by changes in other process variables. The use of static IOWs (each monitoring a single process variable and not accounting for interactions between process variables) may allow unsafe levels of damage to occur as operating conditions change. Also, the use of static IOWs may result in unnecessarily overcautious operations, such as in cases where process variables are constrained to lower or higher values than is actually necessary to constrain damage to acceptable levels. This can result in processes that are less productive than they could be while still operating within acceptable damage rate limits. Furthermore, static IOW limits are typically not evaluated based on actual measurements of damage caused while operating within the IOW limits. Accordingly, it is often unknown whether a static IOW is actually effective in preventing damage to process equipment until the process equipment is taken offline for inspection.

This disclosure provides techniques for real-time dynamic determination of IOW limits that allow (among other things) equipment owners or operators to identify real-time changes in one or more industrial processes that affect the limits of various process variables within which damage caused to process equipment is acceptable. For example, these techniques can be used to identify predicted damage rates to process equipment for different combinations of possible values for multiple interrelated process variables through the use of statistical analysis (such as Monte Carlo analysis) and a damage prediction model. IOW limits for various process variables can be set for a particular piece of process equipment based on the predicted damage rates for various possible operation scenarios identified with the statistical analysis. These techniques can also be used to monitor real-time changes in processes (such as changes to process inputs or throughputs) to dynamically update IOW limits when current IOW limits no longer constrain damage rates within an acceptable range.

In this way, these techniques can be used to more accurately establish initial IOW limits and to dynamically update IOW limits in order to constrain damage rates to an acceptable limit. This helps increase the operational lifetime of the process equipment while reducing the risk of injury to facility personnel and costs due to unexpected equipment failures.

FIG. 1 illustrates an example industrial process control and automation system 100 according to this disclosure. As shown in FIG. 1, the system 100 includes various components that facilitate production or processing of at least one product or other material. For instance, the system 100 can be used to facilitate control or monitoring of components in one or multiple industrial plants. Each plant represents one or more processing facilities (or one or more portions thereof), such as one or more manufacturing facilities for producing at least one product or other material. In general, each plant may implement one or more industrial processes and can individually or collectively be referred to as a process system. A process system generally represents any system or portion thereof configured to process one or more products or other materials in some manner.

In the example shown in FIG. 1, the system 100 includes one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. Each of the sensors 102a includes any suitable structure for measuring one or more characteristics in a process system. Each of the actuators 102b includes any suitable structure for operating on or affecting one or more conditions in a process system.

At least one input/output (I/O) module 104 is coupled to the sensors 102a and actuators 102b. The I/O modules 104 facilitate interaction with the sensors 102a, actuators 102b, or other field devices. For example, an I/O module 104 could be used to receive one or more analog inputs (AIs), digital inputs (DIs), digital input sequences of events (DISOEs), or pulse accumulator inputs (PIs) or to provide one or more analog outputs (AOs) or digital outputs (DOs). Each I/O module 104 includes any suitable structure(s) for receiving one or more input signals from or providing one or more output signals to one or more field devices. Depending on the implementation, an I/O module 104 could include fixed number(s) and type(s) of inputs or outputs or reconfigurable inputs or outputs.

The system 100 also includes various controllers 106. The controllers 106 can be used in the system 100 to perform various functions in order to control one or more industrial processes. For example, a first set of controllers 106 may use measurements from one or more sensors 102a to control the operation of one or more actuators 102b. These controllers 106 could interact with the sensors 102a, actuators 102b, and other field devices via the I/O module(s) 104. A second set of controllers 106 could be used to optimize the control logic or other operations performed by the first set of controllers. A third set of controllers 106 could be used to perform additional functions.

Each controller 106 includes any suitable structure for controlling one or more aspects of an industrial process. At least some of the controllers 106 could, for example, represent proportional-integral-derivative (PID) controllers or multivariable controllers, such as Robust Multivariable Predictive Control Technology (RMPCT) controllers or other types of controllers implementing model predictive control (MPC) or other advanced predictive control. As a particular example, each controller 106 could represent a computing device running a real-time operating system, a MICROSOFT WINDOWS operating system, or other operating system.

Operator access to and interaction with the controllers 106 and other components of the system 100 can occur via various operator stations 110. Each operator station 110 could be used to provide information to an operator and receive information from an operator. For example, each operator station 110 could provide information identifying a current state of an industrial process to an operator, such as values of various process variables and warnings, alarms, real-time dynamic IOW operating limits, or other states associated with an industrial process. Each operator station 110 could also receive information affecting how the industrial process is controlled, such as by receiving setpoints for process variables controlled by the controllers 106 or other information that alters or affects how the controllers 106 control the industrial process. Each operator station 110 includes any suitable structure for displaying information to and interacting with an operator, such as a computing device running a MICROSOFT WINDOWS operating system or other operating system.

A process data historian 112 is coupled to the network 108 in this example. The historian 112 could represent a component that stores various information about the system 100. The historian 112 could, for example, store information used during process control, production scheduling, and optimization. The historian 112 represents any suitable structure for storing and facilitating retrieval of information. Although shown as a single centralized component coupled to the network 108, the historian 112 could be located elsewhere in the system 100, or multiple historians could be distributed in different locations in the system 100. Moreover, in other embodiments, one or more historians 112 may be external to and communicatively coupled to the system 100.

The system 100 also includes a process window management system 114, which is coupled to the network 108 in this example. The process window management system 114 communicates with the historian 112 and other components of the system 100, such as via the network 108, in order to receive data related to operation of the system 100 and the underlying industrial process(es). Based on that data, the process window management system 114 determines upper and/or lower limits for one or more IOWs of one or more controllable process variables. The one or more IOWs here are associated with one or more pieces of process equipment. The IOW limits represent a range of operation for a process variable within which a rate of damage caused to process equipment is acceptable. In some embodiments, the IOW limits may limit the ability of an operator to set, via an operator station 110, a process variable to a setpoint that falls outside of the IOW limits. In other embodiments, if the operator attempts to set a process variable to a setpoint that falls outside of the IOW limits, the process window management system 114 may cause a warning or alarm to display to the operator but may allow the change. Additional details regarding the functionality of the process window management system 114 are provided below.

Additional details regarding the operations of the process window management system 114 are provided below. The process window management system 114 could be implemented in any suitable manner. For example, the system 114 could be implemented using software or firmware instructions that are executed by one or more processors of a computing device, such as a desktop, laptop, server, or tablet computer. The system 114 could also be implemented in other parts of the system 100 and need not represent a stand-alone component, such as when executed by one or more of the operators stations 110 or controllers 106. The system 114 could further be implemented outside of the system 100, such as in remote server, a cloud-based environment, or any other computing system or environment communicatively coupled to the system 100. Note, however, that the prediction system 114 could be implemented in any other suitable manner.

Although FIG. 1 illustrates one example of an industrial process control and automation system 100, various changes may be made to FIG. 1. For example, the system 100 could include any number of sensors, actuators, controllers, networks, operator stations, historians, process window management systems, and other components. Also, the makeup and arrangement of the system 100 in FIG. 1 is for illustration only. Components could be added, omitted, combined, further subdivided, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, while FIG. 1 illustrates one example operational environment where process window management can be used, this functionality can be used in any other suitable system.

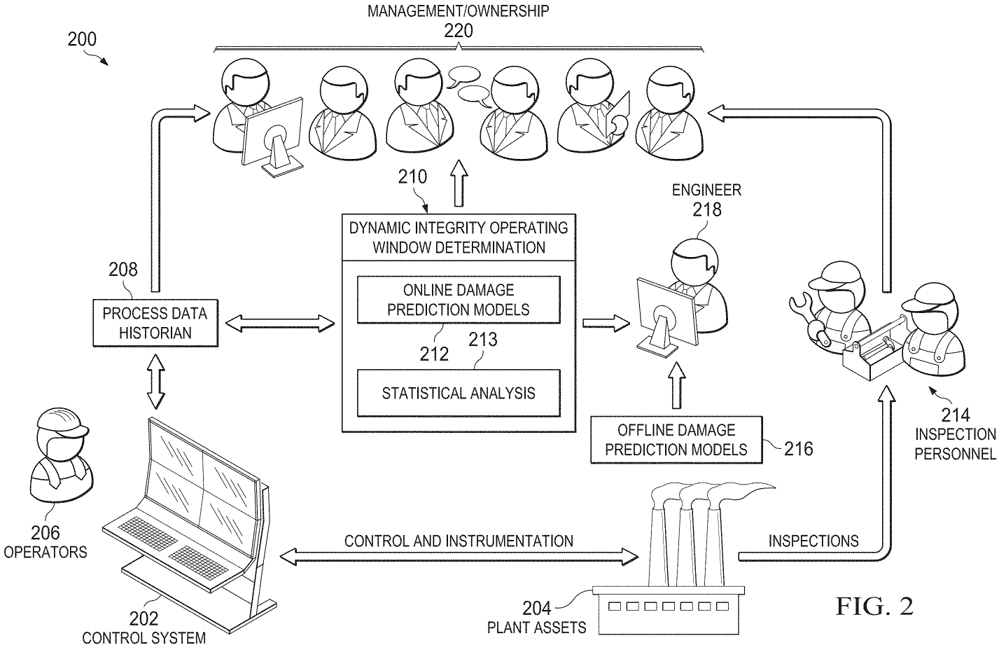

FIG. 2 illustrates an example process window management system 200 according to this disclosure. The process window management system 200 could, for example, be implemented in conjunction with the process window management system 114 of FIG. 1. Note, however, that the system 200 could be used in any other suitable control and automation system.

As shown in FIG. 2, the system 200 includes at least one industrial process control system 202 and various plant assets 204. The plant assets 204 denote the physical process equipment that implements one or more industrial processes, such as equipment used to manufacture chemical, pharmaceutical, paper, or petrochemical products. The control system 202 includes the components in a process control and automation system that manage and control the plant assets 204. The control system 202 could, for example, include part or all of the system 100 shown in FIG. 1.

Various operators 206 use the control system 202 to control the processes implemented by the plant assets 204. For example, operator stations in the control system 202 could provide process data to one or more of the operators 206. The process data may include data identifying the present state of various process variables, such as temperature, pressure, flow rate, damage rate, or the like. Based on the process variables, the operators 206 may use the control system 202 to alter process variables to achieve a desired result, such as by reducing a flow rate of material to lower a predicted damage rate. In some embodiments, the control system 202 provides operators 206 with IOW limits for one or more process variables. The IOW limits could prevent the operators 206 from setting process variables outside of the IOW limits or could display a notification or alarm to an operator 206 that attempts to set a process variable outside of the IOW limits. The system 200 here also includes a process data historian 208, which could denote the historian 112 shown in FIG. 1. As noted above, however, the historian 208 could reside within the control system 202.

A dynamic IOW determination system 210 contains at least one online damage prediction model 212. Each model 212 mathematically represents how damage occurs to at least one piece of process equipment over time given changes in process data values (such as values of one or more process variables). The IOW determination system 210 receives process data values in real-time, such as from the historian 208 or from components of the control system 202. The IOW determination system 210 uses these process data values and the model(s) 212 to determine how damage is predicted to occur in the plant assets 204 as a result of the process data values. For instance, the IOW determination system 210 can use the process data values and the model(s) to quantify damage rates and predict levels of future damage.

In some embodiments, the IOW determination system 210 can communicate with both the historian 208 and the control system 202 in order to import both historical and real-time values of these process variables in real-time. The IOW determination system 210 uses the imported process data values in conjunction with the prediction model(s) 212 to determine real-time predicted damage rates for one or more of the plant assets 204. Thus, the system 210 can identify predicted damage to plant assets 204 in real-time as process data values change.

The IOW determination system 210 can also communicate the real-time predicted damage rates or other calculated data to the historian 208 for storage and to the control system 202. The historian 208 could log the data from the system 210 over time. The control system 202 could use the data in any suitable manner, such as by displaying the damage rates to the operators 206 for observation in real-time.

The IOW determination system 210 contains a statistical analysis unit 213, which could denote one or more processors that execute software/firmware instructions that perform various statistical analyses of data. The statistical analysis unit 213 can use the process data values received from the historian 208 or components of the system 202 to perform statistical modeling of damage rates (such as sensitivity analysis or Monte Carlo simulation) based on the damage prediction model(s) 212. As described below, the statistical models generated by the statistical analysis unit 213 can be used to determine upper and lower IOW limits. The statistical analysis unit 213 can model damage that results from interactions between different process data values and, as a result, IOW limits can be determined that are more effective at preventing damage than IOW limits based only on damage predictions made using single variables.

In some embodiments, the damage prediction models 212 and the statistical analysis unit 213 can be used to dynamically update the IOW limits while the system 200 is online. For example, the IOW determination system 210 can receive process value data in real-time and can use the real-time data to update its statistical models for the system 200. The statistical analysis unit 213 can then run new simulations to determine new IOW limits. The IOW determination system 210 can additionally use the real-time damage predictions provided by the online damage prediction models 212 to supplement the simulation data provided by the statistical analysis unit 213 when determining updated IOW limits. For example, the online damage prediction models 212 can be used to generate real-time damage rate predictions. The system 210 can determine that a real-time predicted damage rate is unacceptable even when operating under current IOW limits, and the system 210 can adjust the IOW limits in real-time to prevent the predicted damage.

In some embodiments, plant assets 204 are also periodically inspected offline by inspection personnel 214. For example, components of the plant assets 204 can be weighed to determine an amount of material that has been removed via corrosion. The inspection data may be used to generate one or more offline damage prediction models 216, which represent the actual damage that occurred to the plant assets 204 over time. Data from the historian 208 could also be used to generate the prediction models 216. The prediction models 216 can be used to mathematically represent actual damage and can be updated periodically, such as each time that an inspection is performed. The prediction models 216 may be used by the IOW determination system 210 to generate or update the online damage prediction models 212 or the statistical models of the statistical analysis unit 213.

One or more engineers or other personnel 218 can review the actual damage data and the predicted damage from both the offline and online prediction models. The personnel 218 may use this comparison to update the prediction models 212, to update the statistical models of the statistical analysis unit 213, to update the IOW limits, or to alter the designs of various plant assets 204.

Management personnel 220 may additionally be able to monitor the data recorded in the historian 208 and receive damage predictions from the IOW determination system 210. The management personnel 220 may also receive inspection reports from the inspection personnel 214 and the offline damage predictions based on the offline prediction models 216. Based on this information, the management personnel 220 may modify operational policies to reduce damage rates, obtain replacements for plant assets 204, or the like.

Although FIG. 2 illustrates one example of a process window management system 200, various changes may be made to FIG. 2. For example, various components in FIG. 2 could be combined, further subdivided, rearranged, or omitted and additional components could be added according to particular needs. As a specific example, various components in FIG. 2 could be integrated into the control system 202.

FIG. 3 illustrates an example device 300 for process window management according to this disclosure. The device 300 could, for example, denote a computing device that executes the process window management system 114 or the dynamic IOW determination system 210. Note, however, that each of these systems could be implemented using any other suitable device.

As shown in FIG. 3, the device 300 includes at least one processor 302, at least one storage device 304, at least one communications unit 306, and at least one input/output (I/O) unit 308. Each processor 302 can execute instructions, such as those that may be loaded into a memory 310. Each processor 302 denotes any suitable processing device, such as one or more microprocessors, microcontrollers, digital signal processors, application specific integrated circuits (ASICs), field programmable gate arrays (FPGAs), or discrete circuitry.

The memory 310 and a persistent storage 312 are examples of storage devices 304, which represent any structure(s) capable of storing and facilitating retrieval of information (such as data, program code, and/or other suitable information on a temporary or permanent basis). The memory 310 may represent a random access memory, buffer, cache, or any other suitable volatile or non-volatile storage device(s). The persistent storage 312 may contain one or more components or devices supporting longer-term storage of data, such as a read only memory, hard drive, Flash memory, or optical disc.

The communications unit 306 supports communications with other systems or devices. For example, the communications unit 306 could include at least one network interface card or wireless transceiver facilitating communications over at least one wired or wireless network, such as the network 108. The communications unit 306 may support communications through any suitable physical or wireless communication link(s).

The I/O unit 308 allows for input and output of data. The I/O unit 308 may provide a connection for user input through a keyboard, mouse, keypad, touchscreen, or other suitable input device. The I/O unit 308 may also send output to a display, printer, or other suitable output device. The user input and output devices for controllers that interface with an operator may, for example, be included in the operator station 110.

Although FIG. 3 illustrates one example of a device 300 for process window management, various changes may be made to FIG. 3. For example, various components in FIG. 3 could be combined, further subdivided, rearranged, or omitted and additional components could be added according to particular needs. Also, computing devices come in a wide variety of configurations, and FIG. 3 does not limit this disclosure to any particular configuration of computing device.

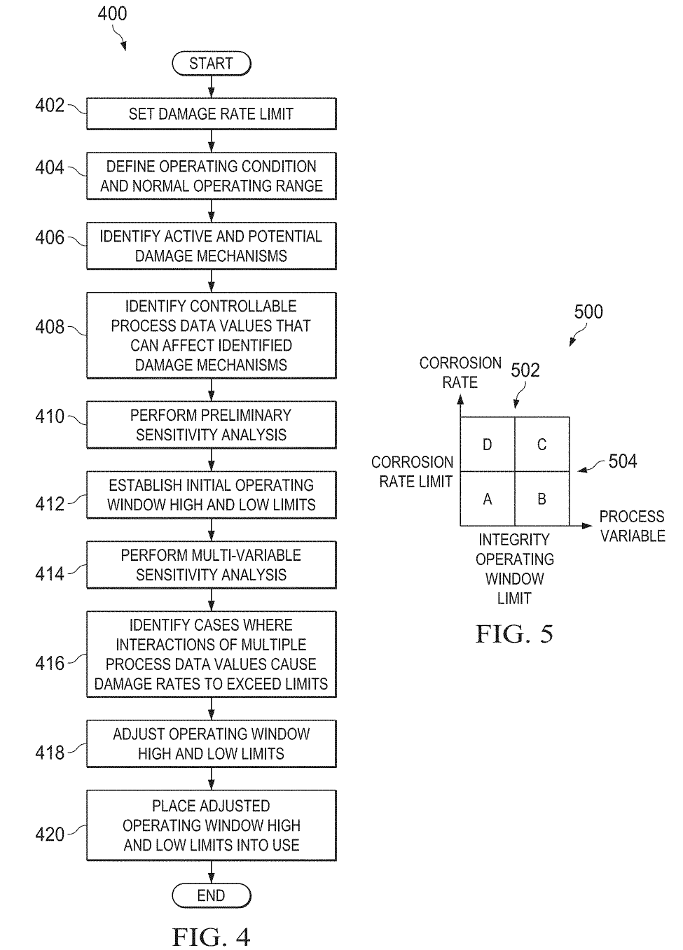

FIG. 4 illustrates an example method 400 for process window management according to this disclosure. For ease of explanation, the method 400 is described with respect to the system 100 of FIG. 1 or the system 200 of FIG. 2, although the method 400 could be implemented in any other suitable system. Also, for ease of explanation, the method 400 is described as being executed by the device 300 of FIG. 3, although any other suitable device could be used to implement the method 400. In addition, the method 400 is described in the context of one underlying industrial process for which a process window is managed, but it is understood that the method 400 could be used for any number of industrial processes in one or more industrial facilities.

At step 402, a damage rate (such as a corrosion rate) limit that should not be exceeded is identified. This damage rate limit could represent the highest acceptable “low rate of degradation.” Process window limits for each process variable will be selected as described below in order to achieve this predictable and reasonable low rate of degradation. Continuous operation within the IOW limits ideally should not result in a degradation rate faster than this damage rate limit. To achieve this goal, each operating scenario considered can satisfy the damage rate limit.

At step 404, a normal operating range and a normal operating condition are defined for each process variable, which are used to evaluate the impact of process variations on damage rates for given process equipment. Although the process equipment may be designed for a specific operating condition, in reality each process variable fluctuates around some “average” operating state, either due to normal process fluctuations or due to process transients during startup, shutdown, or feed changes. If process equipment has different operating modes, each can be documented and considered for analysis. From the point of view of the method 400, each operating mode may be a different iteration of the method 400.

At step 406, active and potential types of damage mechanisms that could occur in the process equipment are identified. This identification may be performed in any suitable manner, such as by using risk-based inspection (RBI) studies, corrosion loops, corrosion reviews, corrosion control documents, equipment risk assessment, process hazards analysis (PHA), or hazards analysis and operability studies (HAZOP).

At step 408, any controllable process variable that may impact the identified damage mechanisms is identified. In some embodiments, process variables may be dependent on each other. For example, temperature, reactive sulfur content, wall shear stress, and alloy type are co-dependent variables that affect high temperature sulfidation in crude oil processing units.

At step 410, a preliminary sensitivity analysis is performed. This sensitivity analysis changes each process variable, one-at-a-time, around the operating condition within the normal operating range of the respective process variable. This enables identifying which process variable has the most impact on damage rates. This also enables determining scenarios with high damage rates for a given process variable and setting initial IOW limits for a dynamic IOW. To help identify initial IOW limit values, the sensitivity analysis can be performed with process variable values that are beyond the normal operating range for the process variable. The sensitivity analysis may be performed, for example, by the statistical analysis unit 213 and may be performed using the damage prediction model 212.

At step 412, initial high and low limits are set to define the process window (the IOW) for each process variable. These limits are set based on the results of the preliminary sensitivity analysis. The initial IOW limits may, for example, be set such that the acceptable damage rate is never exceeded for the normal operating range of the process variable.

At step 414, a multi-variable sensitivity analysis is performed. This analysis is performed by changing multiple process variables at the same time. Depending on the number of process variables changed simultaneously, this analysis may be performed by setting each process variable at a predetermined level (such as by using a set number of combinations) or by using a random distribution of values for each variable (such as by performing Monte Carlo simulations). The multi-variable sensitivity analysis scans the entire set of possible operating scenarios for a piece of equipment, as opposed to moving only one process variable at a time as in the preliminary sensitivity analysis.

At step 416, potential cases where interactions of variables cause damage rates higher than the damage rate limit are identified. For example, this may be done by creating multiple scatter-plots of damage rates versus process variables and identifying the scenarios with high damage rates for each process variable. Unlike single-variable sensitivity analyses where plots are simple line diagrams, these scatter plots can include “clouds” of points that identify the effects of multiple variables on the predicted damage rates. Examples of these scatter-plots are shown below with respect to FIGS. 5, 6, and 7A through 7E.

At step 418, the IOW high and low limits are adjusted. For example, this adjustment may be performed on the basis of the scatter-plots generated at step 416. The scatter-plots indicate operation scenarios where a process variable (or a set of dependent process variables) within the initial IOW limits established at step 412 may still cause an unacceptable damage rate. When such a scenario is identified, the high limit and/or low limit for that variable, or for two or more dependent variables of the set of variables, may be adjusted accordingly to prevent operation scenarios with unacceptably high damage rates.

At step 420, the adjusted IOW high and low limits are placed into use. For example, the adjusted IOW high and low limits could be provided to one or more controllers, operator stations, or other components and used during actual control operations for the process equipment. As noted above, a warning or alarm could be display when an operator attempts a change that violates the adjusted IOW high and low limits.

Although FIG. 4 illustrates one example of a method 400 for process window management, various changes may be made to FIG. 4. For example, while shown as a series of steps, various steps in FIG. 4 could overlap, occur in parallel, occur in a different order, or occur any number of times.

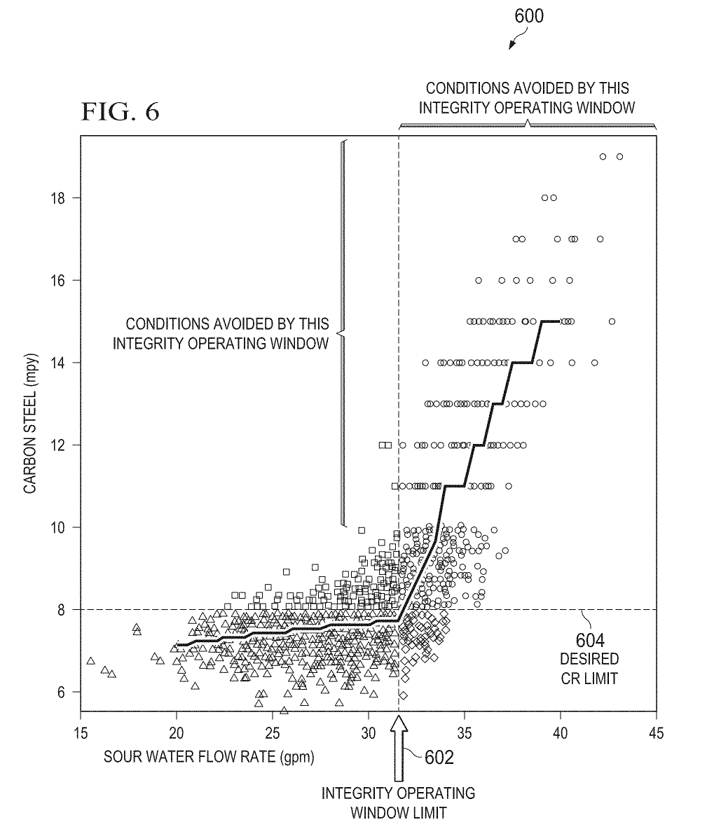

FIGS. 5 and 6 illustrate example graphs that plot a process variable versus predicted damage rates with respect to a process window according to this disclosure. In particular, FIG. 5 illustrates a graph form 500, and FIG. 6 illustrates a particular graph 600 having this form. In each figure, a process variable is plotted again predicted damage rates (labeled as corrosion) caused by an underlying process.

In FIG. 5, quadrant A represents operation scenarios in which process variables are below a current IOW limit 502 and damage rates are below a damage rate limit 504. While one IOW limit 502 is displayed here, it is understood that this could be a high or low IOW limit depending on the process variable in question and that multiple IOW limits 502 could be presented. Operating in this quadrant is the desired mode of operation. Ideally, the IOW limit 502 is generally set to maximize the number of operation scenarios that are in this quadrant.

Quadrant B represents operation scenarios in which process variables are higher than the current IOW limit 502 and damage rates are below the damage rate limit 504. Operating in this quadrant can be avoided by use of the IOW limit 502, but damage rates are still lower than the damage rate limit 504. Operation within this quadrant may trigger an alert or other action due to exceeding the IOW limit 502 for a process variable, but the actual damage rate would be lower than the acceptable damage rate limit 504. This may be known as a “false positive” quadrant. Depending on the underlying process, operating in this quadrant may correspond to a lost production opportunity.

Quadrant C represents operation scenarios in which process variables are higher than the IOW limit 502 and damage rates are higher than the damage rate limit 504. This is the operating quadrant that the IOW limit 502 is designed to avoid. When setting the IOW limit 502, one intent is to avoid operation scenarios in this quadrant.

Quadrant D represents operation scenarios in which process variables are below the IOW limit 502 and damage rates are higher than damage rate limit 504. This may be known as a “false negative” quadrant. The IOW limit 502 is not exceeded (so no alarms or other actions are triggered), but damage rates above the acceptable damage rate limit 504 are present. Operation in this quadrant for extended periods can cause damage to equipment that could remain undetected until an offline inspection. Such damage could result in a costly or dangerous failure of equipment if not discovered. Operation in this quadrant should be avoided. In some embodiments, online real-time prediction and monitoring of damage rates may be implemented to detect operation in this quadrant.

As shown in FIG. 6, the graph 600 plots the damage rate versus one process variable, and the graph 600 here is a scatter-plot. Each point on the graph 600 represents a damage rate for a simulated operating scenario based on the indicated process variable value, as well as values of other process variables that are not labeled on the graph 600 as inputs. Accordingly, different damage rates are possible for the same process variable value on graph 600. These simulated operation scenarios may be generated, for example, in step 414 of FIG. 4, such as by a Monte Carlo simulation. In this particular example graph, a damage rate to a carbon steel pipe is plotted on the Y-axis, and the process variable value of sour water flow rate is plotted on the X-axis.

In some embodiments, a Monte Carlo simulation can be run using the statistical analysis unit 213. A Monte Carlo simulation generates a number of simulated process data variable values for a particular damage mechanism of a process in order to determine a number of predicted damage rates for the process. For example, a Monte Carlo simulation of damage caused by hydrogen sulfide and ammonia may include generating many random sets of possible values for the process values pressure, temperature, ammonium bisulfide concentration, hydrogen sulfide partial pressure, cyanide content, hydrocarbon content, flow regimes, and wall shear stress. Each set of process variables is input into the statistical analysis unit 213, and damage rates that would result from the set of inputs are recorded and can be displayed in the graph 600.

Note that the graph 600 is for illustrative purposes only and that operators 206, management personnel 220, or other users may not see this graph. In other embodiments, the graph 600 may be displayed to users, such as via the operator stations 110, or the graph 600 may be stored for later review by users, such as in the historian 208.

In FIG. 6, each point on the graph 600 represents the result of one iteration of the Monte Carlo simulation. This means each point represents a predicted damage rate that is determined for a randomly-chosen set of process variable values for multiple process variables, such as those determined at step 408 of FIG. 4).

The area below both an IOW limit 602 (the process window limit) and a desired damage limit 604 corresponds to quadrant A of the graph 500 and represents desirable operation scenarios. The IOW limit 602 of FIG. 6 may correspond to the initial IOW limit determined in step 412 of FIG. 4 based on single variable sensitivity analysis. The area above the IOW limit 602 but below the desired damage limit 604 corresponds to quadrant B of the graph 500 and represents false positive operation scenarios where the process will not cause unacceptable damage but operation may be reduced or prevented nonetheless, resulting in lost production opportunity. The area above the IOW limit 602 and above the desired damage limit 604 corresponds to quadrant C of the graph 500 and represents unacceptable operation scenarios. In these scenarios, alarms can be sounded or production may correctly be shut down to prevent unacceptable damage. The area below the IOW limit 602 but above the desired damage limit 604 corresponds to quadrant D of the graph 500 and represents false negative operation scenarios where unacceptable damage will be caused but operation will not be altered or prevented by the IOW limit 602. Based on the amount of operation scenarios that are in quadrants B and D, the IOW limit 602 in FIG. 6 may need to be adjusted, such as is described in step 418 of FIG. 4.

In this example graph 600, it may be determined that there are too many false negatives (points in quadrant D), and the IOW limit 604 should be lowered to prevent potential scenarios where damage rates exceed the acceptable damage rate limit 604. In some embodiments, it may be determined from the example graph 600 that reasonable IOW limits allowing acceptable production while also avoiding operating conditions resulting in unacceptable damage cannot be established. In such cases, real-time prediction of damage rates may be implemented, such as by using the online damage prediction model 212, to monitor the process in addition to the use of an IOW limit. For example, real-time predictions of damage rates may be provided to an operator 206 via an operator station, and the operator may adjust process variables in real-time to reduce the predicted damage rate. The models used to perform real-time prediction may be the same models used to run the Monte Carlo simulations that result in the graph 600.

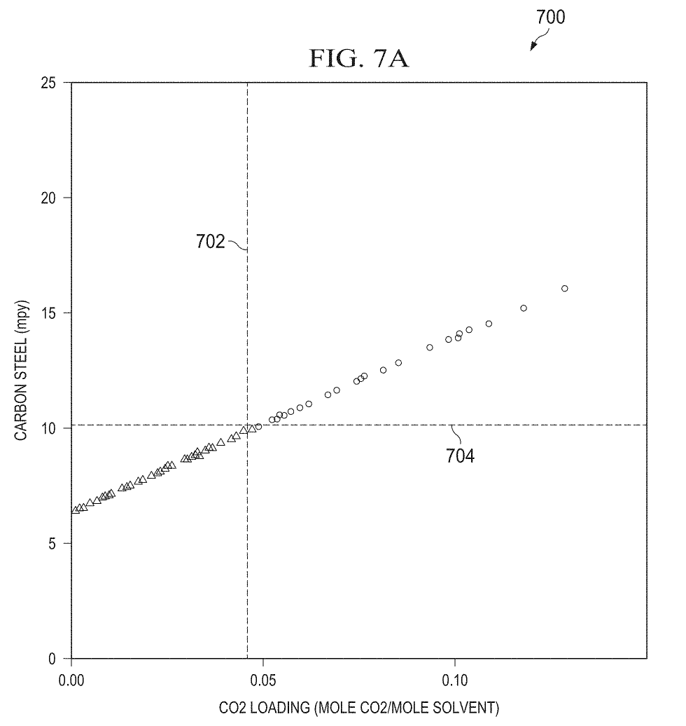

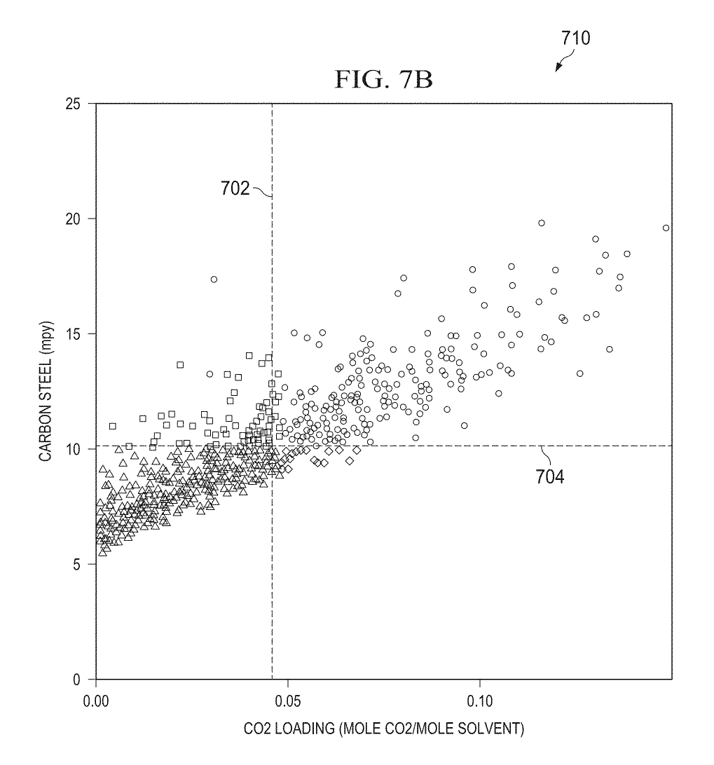

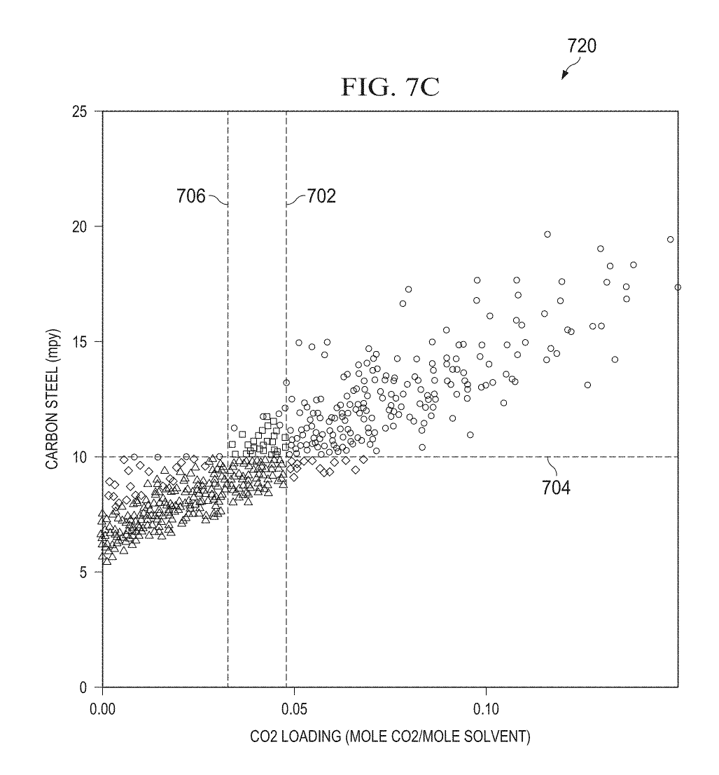

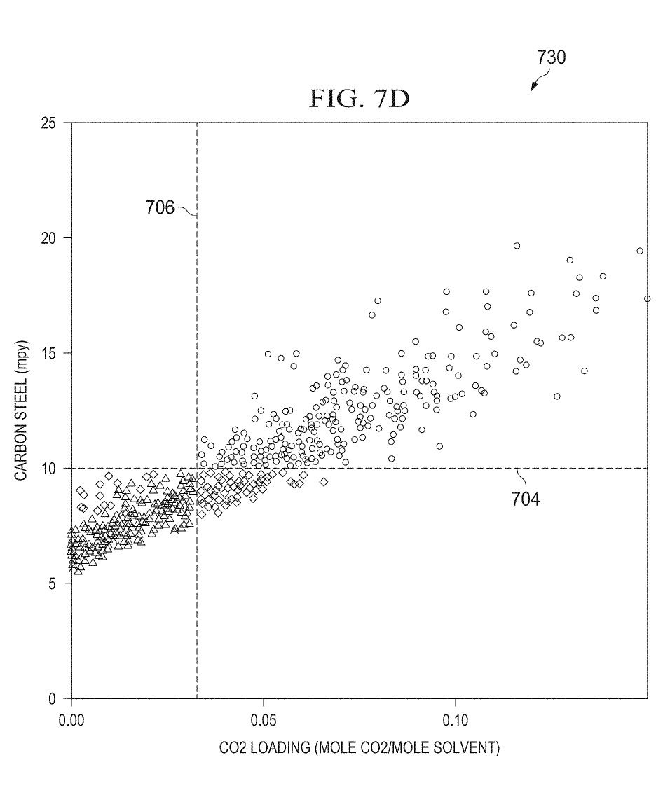

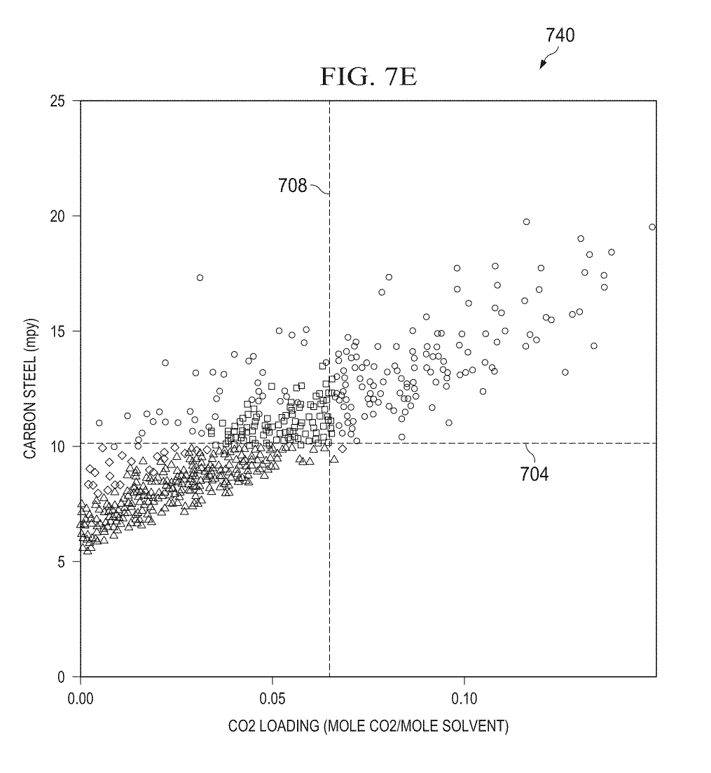

FIGS. 7A through 7E illustrate example graphs of results of damage rate simulations for a specific example process window according to this disclosure. The examples in FIGS. 7A through 7E show analysis of damage caused by rich amine corrosion, which may be identified as a damage mechanism at step 406 of the method 400.

In this example, IOW limits are determined for an 8-inch carbon steel piping section carrying rich amine (18% wt) monoethanolamine (MEA). In order to achieve a desired operating life of the piping section, the damage rate should not exceed 10 mils per year (mpy), which can be set at step 402 of the method 400. The controllable process variables are identified (such as at step 408 of the method 400) to be temperature, flow rate, H₂S loading (mol H₂S/mol MEA), CO₂ loading (mol CO₂/mol MEA), amine flow rate, and impurities. Normal operating conditions (such as those identified at step 404 of the method 400) are 2,000 gpm flow rate at 135° F. with 0.5 mol H₂S/mol MEA. Executing an amine damage model (a specific instance of a prediction model 212) with these normal operating conditions results in a predicted damage rate of 6.3 mpy, which is below the acceptable limit of 10 mpy. However, there may be a range of possible operating limits for these process variables that could result in a change to the damage rate, and there could be interactions between the variables that result in changes to the damage rate. Table 1 shows the above operating conditions and an expected normal operating range for each process variable.

TABLE 1

| | Normal | Normal Operating |
|---|---|---|
| Variable | Conditions | Range |
| Temperature (° F.) | 135 | 130-145 |
| H₂S loading (mol H₂S/mol MEA) | 0.5 | 0.4-0.6 |
| CO₂ loading (mol CO₂/mol MEA) | 0 | 0-0.1 |
| Amine flow rate (gpm) | 2000 | 1900-2100 |
| Impurities (% wt) | 0.5 | 0-2 |

FIG. 7A illustrates a graph 700 of the results of a single-variable sensitivity analysis for the CO₂ loading variable. This single-variable sensitivity analysis may correspond to the single-variable sensitivity analysis performed in step 410 of the method 400. As seen in the graph 700, an acceptable damage rate 704 may be exceeded when the CO₂ loading exceeds 0.48 mol/mol. Accordingly, an initial IOW limit 702 may be set, such as is described in step 412 of the method 400. A single-variable sensitivity analysis is also performed on the other process variables shown in Table 1. It may be determined that only the impurities variable shows a possibility of causing the damage rate to exceed the acceptable damage rate 704, and its initial IOW limit is determined to be 1.6% wt impurities (not shown).

FIG. 7B illustrates a graph 710 of the damage rate predictions resulting from of a multi-variable sensitivity analysis plotted versus the CO₂ loading variable. The multi-variable sensitivity analysis may be performed in accordance with, for example, step 414 of the method 400. The multi-variable sensitivity analysis reveals that interactions between the process variables can result in scenarios where damage rates exceed the acceptable damage rate 704 while falling below the initial IOW limit 702. Accordingly, such scenarios could cause unacceptable damage while going undetected by the initial IOW limit 702 that was determined based on a single-variable sensitivity analysis.

FIG. 7C illustrates a graph 720 of the damage rate predictions resulting from a multi-variable sensitivity analysis plotted versus the CO₂ loading variable after the IOW limit of the impurities process variable has been reduced from 1.6% wt to 0.8% wt. The spread of undetected high corrosion rate scenarios is reduced to a small window. The relationship between the impurities variable and the CO₂ loading variable is visible in the graph 720. It is also apparent from the graph 720 that reducing the initial IOW limit 702 from 0.48 mol/mol to 0.33 mol/mol (represented by an updated IOW limit 706) eliminates most or all undetected high corrosion rate scenarios. The updated IOW limit 706 may, in some embodiments, be selected based on a specified number of undetected high corrosion rate scenarios that are acceptable. This determination may be made if a number of operation scenarios that are above the acceptable damage rate 704 but below the IOW limit 702 exceeds the specified number. The specified number may be determined based on a trade-off between lost production opportunity and risk of damage. For example, when the cost of an amount of damage to the equipment that is predicted when operating under the initial IOW limit 702 outweighs an amount of lost production associated with the use of the updated IOW limit 706, the IOW limit 706 may be used.

FIG. 7D illustrates a graph 730 of the damage rate predictions resulting from a multi-variable sensitivity analysis plotted versus the CO₂ loading variable after the IOW limit of the CO₂ loading variable has been moved from the initial IOW limit 702 to the updated IOW limit 706. The undetected high corrosion rate scenarios have been essentially eliminated. However, it may be the case that setting the IOW limit at the updated IOW limit 706 results in a large loss of production opportunity. Accordingly, it may be desirable to set multiple different IOW limits that result in different notifications to operators 206, management personnel 220, or other users in order to allow the users to determine an acceptable trade-off between the chance of undetected high corrosion rate scenarios and loss of production opportunity. For instance, if the CO₂ loading variable exceeds the IOW limit 706, an informational notification message may be provided to an operator 206 informing the operator that the IOW limit 706 has been exceeded. If the CO₂ loading variable exceeds the initial IOW limit 702, a low risk alert may be provided to the operator 206, informing the operator that the initial IOW limit 702 has been exceeded and there is a low risk of damage to the piping. In some cases, an alarm notification may be provided to an operator 206 when the IOW limit 702 is exceeded, but operation may be permitted to continue. In these cases, the IOW limits 702 and 706 may be determined based on a number of undetected high corrosion rate scenarios that are predicted to occur when operating under each respective IOW limit, which are compared to production that would be lost by adjusting the IOW limit.

FIG. 7E illustrates a graph 740 of the damage rate predictions resulting from a multi-variable sensitivity analysis plotted versus the CO₂ loading variable when the IOW limit has been adjusted to a high risk IOW limit 708. The high risk IOW limit 708, which is 0.66 mol/mol, results in an almost certainty that undetected high damage rate operation scenarios will occur. If the CO₂ loading variable exceeds the high risk IOW limit 708, a high risk alarm may be generated and sent to an operator 206, or the process may be automatically shut down. As described above, the IOW limit 708 may be determined based on a number of undetected high corrosion rate scenarios that are predicted to occur when operating under each respective IOW limit, which are compared to production that would be lost by adjusting the IOW limit.

Although FIGS. 5 through 7E illustrate example graphs, various changes may be made to FIGS. 5 through 7E. For example, the contents of these graphs are for illustration only and are meant to illustrate features of dynamic process window management. The contents of the graphs in FIGS. 5 through 7E do not limit the scope of this disclosure.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for process window control, comprising:
obtaining data associated with a plurality of variables of an industrial process;
obtaining an indication of an acceptable damage rate to equipment that is used in the industrial process;
obtaining a damage prediction model for the equipment, wherein the damage prediction model mathematically represents expected damage to the equipment based on the plurality of variables; and
determining at least one of a high limit and a low limit for each of the plurality of variables based on predicted damage rates to the equipment that are determined using the data and the damage prediction model.

2. The method of claim 1, wherein determining at least one of the high limit and the low limit for each of the plurality of variables comprises:
determining multiple predicted damage rates to the equipment based on a plurality of sets of values of the plurality of variables associated with a plurality of predicted operation scenarios; and
in response to at least a specified number of the predicted damage rates exceeding the acceptable damage rate, adjusting the high limit or the low limit for at least one of the variables to reduce the number of predicted damage rates exceeding the acceptable damage rate.

3. The method of claim 2, further comprising:
identifying the specified number based on a determination that an amount of damage to the equipment outweighs an amount of lost production associated with use of the adjusted high or low limit.

4. The method of claim 1, further comprising:
in response to at least one of the plurality of variables exceeding its high or low limit, at least one of: generating an alarm and shutting down the process.

5. The method of claim 1, further comprising:
determining at least one of an additional high limit and an additional low limit for each of the plurality of variables.

6. The method of claim 5, further comprising:
in response to at least one of the plurality of variables exceeding its additional high or low limit, generating an informational notification message.

7. The method of claim 2, further comprising:
identifying predicted operation scenarios in which an interaction between two or more of the variables results in a predicted damage rate that exceeds the acceptable damage rate;
wherein adjusting the high limit or the low limit for at least one of the variables comprises adjusting the high limit or the low limit for one of the two or more variables to reduce an amount of predicted damage caused by another of the two or more variables.

8. An apparatus comprising:
at least one memory configured to store:
data associated with a plurality of variables of an industrial process;
an indication of an acceptable damage rate to equipment that is used in the industrial process; and
a damage prediction model for the equipment, wherein the damage prediction model mathematically represents expected damage to the equipment based on the plurality of variables; and
at least one processing device configured to determine at least one of a high limit and a low limit for each of the plurality of variables based on predicted damage rates to the equipment that are determined using the data and the damage prediction model.

9. The apparatus of claim 8, wherein, to determine at least one of the high limit and the low limit for each of the plurality of variables, the at least one processing device is configured to:
determine multiple predicted damage rates to the equipment based on a plurality of sets of values of the plurality of variables associated with a plurality of predicted operation scenarios; and
in response to at least a specified number of the predicted damage rates exceeding the acceptable damage rate, adjust the high limit or the low limit for at least one of the variables to reduce the number of predicted damage rates exceeding the acceptable damage rate.

10. The apparatus of claim 9, wherein the at least one processing device is further configured to identify the specified number based on a determination that an amount of damage to the equipment outweighs an amount of lost production associated with use of the adjusted high or low limit.

11. The apparatus of claim 8, wherein the at least one processing device is further configured, in response to at least one of the plurality of variables exceeding its high or low limit, to at least one of: generate an alarm and shut down the process.

12. The apparatus of claim 8, wherein the at least one processing device is further configured to determine at least one of an additional high limit and an additional low limit for each of the plurality of variables.

13. The apparatus of claim 12, wherein the at least one processing device is further configured, in response to at least one of the plurality of variables exceeding its additional high or low limit, to generate an informational notification message.

14. The apparatus of claim 9, wherein:
the at least one processing device is further configured to identify predicted operation scenarios in which an interaction between two or more of the variables results in a predicted damage rate that exceeds the acceptable damage rate; and
to adjust the high limit or the low limit for at least one of the variables, the at least one processing device is configured to adjust the high limit or the low limit for at least one of the two or more variables to reduce an amount of predicted damage caused by another of the two or more variables.

15. A non-transitory computer readable medium containing computer readable program code that when executed causes at least one processing device to:
obtain data associated with a plurality of variables of an industrial process;
obtain an indication of an acceptable damage rate to equipment that is used in the industrial process;
obtain a damage prediction model for the equipment, wherein the damage prediction model mathematically represents expected damage to the equipment based on the plurality of variables; and
determine at least one of a high limit and a low limit for each of the plurality of variables based on predicted damage rates to the equipment that are determined using the data and the damage prediction model.

16. The non-transitory computer readable medium of claim 15, wherein the computer readable program code that when executed causes the at least one processing device to determine at least one of the high limit and the low limit for each of the plurality of variables comprises:
computer readable program code that when executed causes the at least one processing device to:
determine multiple predicted damage rates to the equipment based on a plurality of sets of values of the plurality of variables associated with a plurality of predicted operation scenarios; and
in response to at least a specified number of the predicted damage rates exceeding the acceptable damage rate, adjust the high limit or the low limit for at least one of the variables to reduce the number of predicted damage rates exceeding the acceptable damage rate.

17. The non-transitory computer readable medium of claim 16, further containing computer readable program code that when executed causes the at least one processing device to:
identify the specified number based on a determination that an amount of damage to the equipment outweighs an amount of lost production associated with use of the adjusted high or low limit.

18. The non-transitory computer readable medium of claim 15, further containing computer readable program code that when executed causes the at least one processing device to:
in response to at least one of the plurality of variables exceeding its high or low limit, at least one of: generate an alarm and shut down the process.

19. The non-transitory computer readable medium of claim 15, further containing computer readable program code that when executed causes the at least one processing device to:
determine at least one of an additional high limit and an additional low limit for each of the plurality of variables; and
in response to at least one of the plurality of variables exceeding its additional high or low limit, generate an informational notification message.

20. The non-transitory computer readable medium of claim 16, further containing computer readable program code that when executed causes the at least one processing device to identify predicted operation scenarios in which an interaction between two or more of the variables results in a predicted damage rate that exceeds the acceptable damage rate;
wherein the computer readable program code that when executed causes the at least one processing device to adjust the high limit or the low limit for at least one of the variables comprises:
computer readable program code that when executed causes the at least one processing device to adjust the high limit or the low limit for at least one of the two or more variables to reduce an amount of predicted damage caused by another of the two or more variables.
